(19) United States
(12) Patent Application Publication
(10) Pub. No.: US 2003/0055856 A1
(43) Pub. Date: Mar. 20, 2003

(54) Architecture component and method for performing discrete wavelet transforms

(76) Inventors: Paul Gerard McCanny, Sion Mills (GB); Shahid Masud, Carryduff (GB); John Vincent McCanny, Newtownards (IE)

Correspondence Address: Curtis L. Harrington, Suite 250, 6300 State University Drive, Long Beach, CA, 90815, US

(21) Appl. No.: 09/957,292

(22) Filed: Sep. 19, 2001

(51) Int. Cl. G06F 17/14

(52) U.S. Cl. 708/400; 708/401

(57) ABSTRACT

Architecture and method for performing discrete wavelet transforms An architecture component an a method for use in performing a 2-dimensional discrete wavelet transform of 2-dimensional input data is disclosed. The architecture component comprises a serial processor for receiving the input signal row-by-row, a memory for receiving output coefficients from the serial processor, and a parallel processor for processing coefficients stored in the memory and a serial processor for processing further octaves. The parallel processor is operative to process in parallel coefficients previously derived from one row of input data by the serial processor.

This invention relates to an architecture component for performing discrete wavelet transforms.

There has been a growing interest in the use of discrete wavelet transforms (DWT). This increase has, in part, been brought about by adoption of the JPEG2000 standard for still and moving image coding and compression set out by the Joint Picture Experts Group, which, it is intended, will be standardised by the International Standards Organization in International Standard, IS 15444 Part 1. Central to the JPEG2000 standard is the use of a separable 2-dimensional DWT that use biorthogonal 9,7 and 5,5 filter pairs to perform, respectively, irreversible and reversible compression.

Moreover, wavelet analysis finds other applications for several reasons. One of these reasons is that it can be performed over a part of an original signal that is limited in time. The time over which the analysis operates can be varied simply by making relatively small changes to the analysis procedure. This allows the analysis to be tuned to give results that are more accurate in either their resolution in frequency or in time, as best suits the objective of the analysis (although, it should be noted, that an increase in accuracy in one domain will inevitably result in a decrease in accuracy in the other).

A two-dimensional wavelet transform can be implemented either as a non-separable or as a separable transform. The former type of transform cannot be factorised into Cartesian products. In contrast, a separable transform can be implemented by performing a 1-dimensional transform along one axis before computing the wavelet transform of the coefficients along an orthogonal axis. The separable implementation is therefore the more commonly used implementation of a 2-dimensional transform because it is an inherently efficient implementation and allows use of existing 1-dimensional architectures.

There is, therefore, a demand for design methodologies that can implement a separable 2-dimensional DWT in VLSI hardware efficiently both in terms of performance and complexity, for example, as a DSP core.

Hitherto, several systems for implementing separable 2-dimensional DWTs have been proposed. A simple system uses a serial processor that computes the transform for all rows of an N×N data set and stores the result in a storage unit of size N×N. Once all of the rows have been processed, the same processor calculates the DWT of all of the columns. Such an architecture computes the 2-dimensional transform in O(2N²) cycles.

Extensions to this simple architecture have been proposed, which have a reduced storage requirement as a trade-off against use of additional processors. These architectures have the capability of calculating a 2-dimensional transform in O(N+N²) cycles. In terms of their computational performance, the most advantageous of such architectures are based on RPA.

In order that this invention can be better understood, known procedures for calculating a multilevel DWT in one dimension at various different resolutions will be reviewed.

One approach is to calculate the wavelet transform for the entire set of input data, and store the outputs when calculation has completed for each resolution level or octave. The low-pass outputs from each level of computation are then used as the inputs for the next octave. This approach is straightforward to implement, but requires a large amount of storage capacity for intermediate results.

An alternative approach is to interlace computation of the various octaves. This avoids the need to wait for the results calculated coefficients of one octave before calculation of the next octave can be started, with a consequent saving in processing time and memory requirements. The algorithm known as the Recursive Pyramid Algorithm (RPA) can compute coefficients as soon as the input data is available to be processed.

In two dimensions, a modified version of the 1-dimensional RPA algorithm may be used to produce an algorithm that is efficient in its use of processing cycles. However, this introduces a delay in the timing of the outputs of the transform. This means that the scheduling that must take place to implement such algorithms is complex. Moreover, many such architectures incorporate multiple components, which, because of interlacing, are active for only a proportion (e.g. 50%) of time during calculation of the transform. A consequence of this is that the hardware required to implement these algorithms is typically complex, costly and difficult to implement.

An aim of this invention is to provide an efficient implementation of a 2-dimensional, separable wavelet transform that has a wide range of application including, in particular, JPEG2000 coding applications, while reducing one or more of the memory requirements, complexity and inefficiency of hardware use of known architectures.

From a first aspect, this invention provides an architecture component for use in performing a 2-dimensional discrete wavelet transform of 2-dimensional input data, the component comprising a serial processor for receiving the input signal row-by-row, a memory for receiving output coefficients from the serial processor, a parallel processor for processing coefficients stored in the memory, in which the parallel processor is operative to process in parallel coefficients previously derived from one row of input data by the serial processor.

The input data is, therefore, scanned along each row in turn, essentially in a raster-like scan. This can be implemented without the timing complexities associated with RPA, which results in an advantageously simple hardware configuration. In one dimension, it is not essential and therefore generally not practical to store all of the coefficients for one level before going on to the next, since this would require provision of a large amount of additional memory. However, storage of calculated coefficients is a requirement in 2-D separable systems, so the memory used to store these intermediate results is not an overhead; it is an essential. Therefore, in this invention, the coefficients of an entire row are generated, ordered and processed before the next row is processed. This can provide an architecture that has advantageously simplified timing and configuration in general. This architecture can be thought of as combining advantageous features of each of the above proposals.

The serial processor may generate both low-pass and high-pass filter output coefficients. The memory is, in such cases, typically capable of storing both such output coefficients. In such cases, the parallel processor may be operative to process combinations of the output coefficients in successive processing cycles.

Most advantageously, the memory is configured to order coefficients stored in it into an order suitable for processing by the parallel processor.

The memory may be configured to process coefficients contained in it in a manner that differs in dependence upon whether the coefficients are derived from an odd-numbered or an even-numbered row in the input data.

The parallel processor and the memory are typically driven by a clock. The memory may produce an output at a rate half that at which the parallel processor produces an output.

In order to ameliorate the errors introduced into the transform by an abrupt start and end of the input signal (so-called “edge effects”), the data is most typically extended. In some embodiments, the data is extended at its borders by symmetric extension. Alternatively, the data may be extended at its borders by zero padding. Extension of the data may be performed in a memory unit of the architecture or within a delay line router component of the architecture.

In an architecture component embodying the invention, the parallel processor is advantageously configured to process data at substantially the same rate as data is output by the serial processor. This ensures that use of the processing capacity of the parallel processor is maximised. For example, the serial processor may be configured to produce two output coefficients every 2n clock cycles, and the parallel processor is configured to process one input coefficient every n clock cycles (where n is an integer). Moreover, the parallel processor advantageously produces an output only for every second data row processed by the architecture. This can ensure that no data (or, at least, a minimum of data) is processed that might subsequently be lost through decimation.

An architecture component embodying the invention may further comprise a second serial processor. The second serial processor operates to process output from the parallel processor to generate one or more further octaves of the DWT. Typically, only a proportion (typically 25%) of coefficients produced by the parallel processor are processed by the second serial processor. In this case, the second serial processor is configured to process data at half the rate of the first serial processor.

An architecture component embodying the invention may be a component in a system for performing image processing according to the JPEG2000 standard.

From a second aspect, the invention provides a method of performing a 2-dimensional discrete wavelet transform comprising processing data items in a row of data in a serial processor to generate a plurality of output coefficients, storing the output coefficients, and processing the stored coefficients in a parallel processor to generate the transform coefficients.

A method according to this aspect of the invention typically further includes reordering the coefficients before input to each processor. It may also include extending the data at its borders in the memory device. Such extension may be done by way of either one of zero padding or symmetric extension.

A method according to this aspect of the invention may be part of a method of encoding or decoding an image according to the JPEG 2000 standard.

The architecture component may be implemented in a number of conventional ways, for example as an Application Specific Integrated Circuit (ASIC) or a Field Programmable Gate Array (FPGA). The implementation process may also be one of many conventional design methods including standard cell design or schematic entry/layout synthesis. Alternatively, the architecture component may be described, or defined, using a hardware description language (HDL) such as VHDL, Verilog HDL or a targeted netlist format (e.g. xnf, EDIF or the like) recorded in an electronic file, or computer useable file.

Thus, the invention further provides a computer program, or computer program product, comprising program instructions, or computer usable instructions, arranged to generate, in whole or in part, an architecture component according to the invention. The architecture component may therefore be implemented as a set of suitable such computer programs. Typically, the computer program comprises computer usable statements or instructions written in a hardware description, or definition, language (HDL) such as VHDL, Verilog HDL or a targeted netlist format (e.g. xnf, EDIF or the like) and recorded in an electronic or computer usable file which, when synthesised on appropriate hardware synthesis tools, generates semiconductor chip data, such as mask definitions or other chip design information, for generating a semiconductor chip. The invention also provides said computer program stored on a computer useable medium. The invention further provides semiconductor chip data, stored on a computer usable medium, arranged to generate, in whole or in part, a architecture component according to the invention.

An embodiment will now be described in detail, by way of example, and with reference to the accompanying drawings, in which:

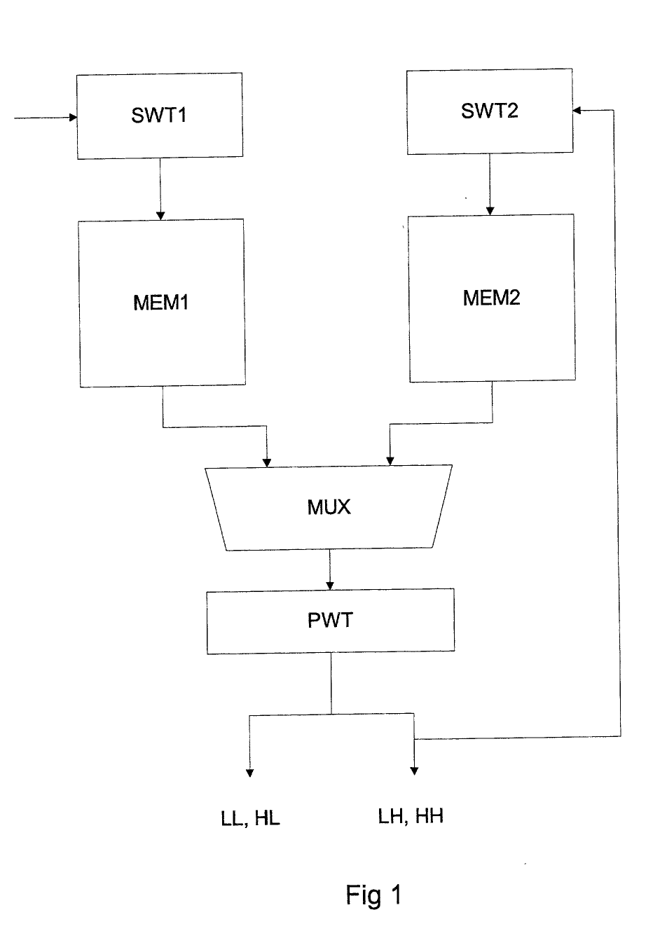

FIG. 1 is a block diagram of a architecture component of a first embodiment of the invention;

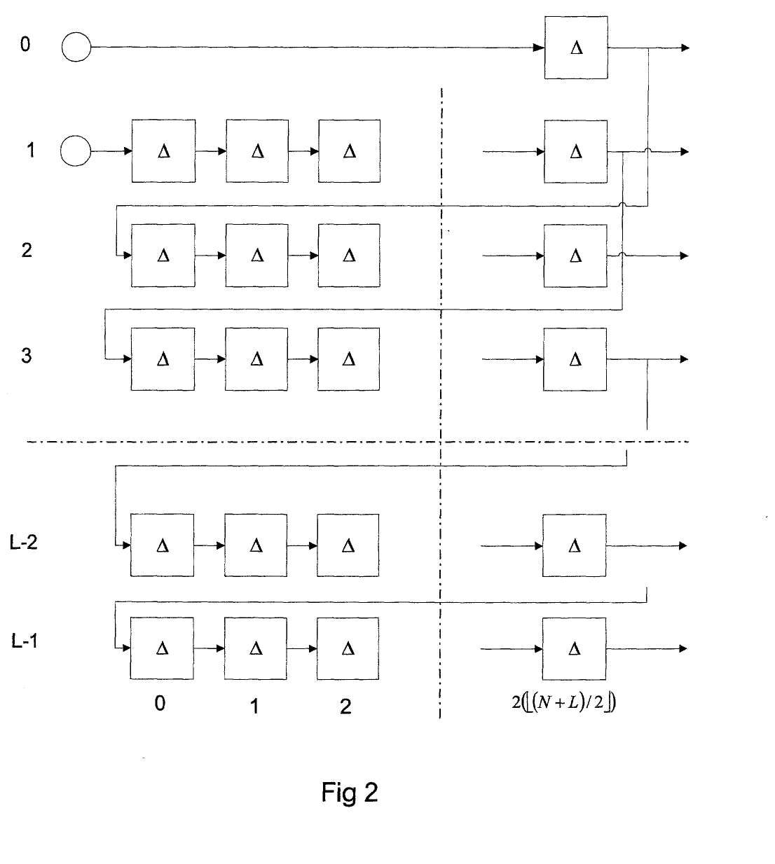

FIG. 2 is a block diagram on a memory unit of the embodiment of FIG. 1;

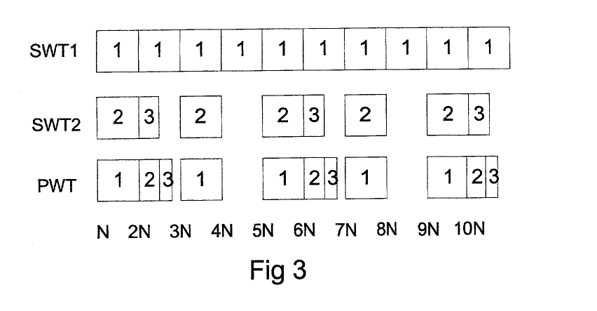

FIG. 3 is a timing diagram illustrating component utilisation in the first embodiment of the invention;

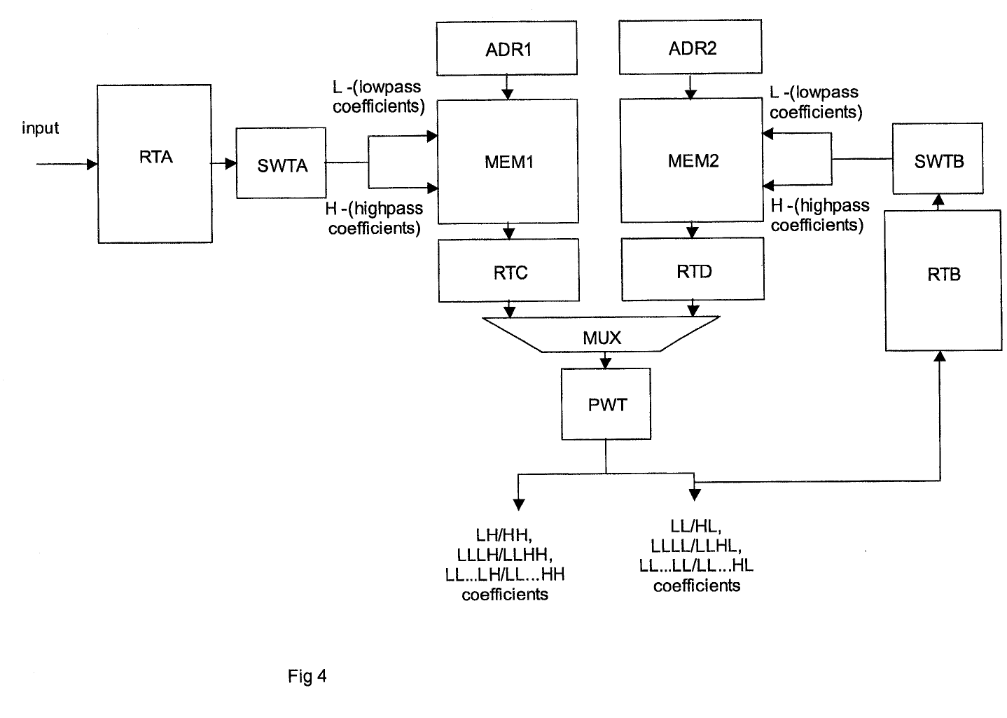

FIG. 4 is a block diagram of a circuit architecture of a second embodiment of the invention.

With reference to FIG. 1, there is shown the basic components of a circuit embodying the invention. This embodiment is intended to process a 2-dimensional array of data, such as an image, of size N×M.

The embodiment comprises first and second serial processors SWT1, SWT2; a first and a second memory unit MEM1, MEM2; a multiplexer MUX; and a parallel processor PWT. Each of these components is controlled by a common clock.

The first serial processor SWT1 is a 1-dimensional serial filter, which receives data from an N×M input matrix in row order, receiving one value at each clock cycle. The first serial processor SWT1 produces two outputs every six clock cycles; one being a low-pass coefficient (L) and one being a high-pass coefficient (H).

Output coefficients produced by the first serial processor SWT1 are stored in the first memory unit MEM1. The first memory unit MEM1 stores both sets of coefficients L, H received from the first serial processor SWT1, and transposes the input value into a form suitable for processing by the parallel processor PWT.

The parallel processor PWT produces an output every three clock cycles by operating on coefficients stored in the first memory unit MEM1. The parallel processor PWT operates to combine the two sets of output coefficients L and H of the first serial processor SWT1 in the four possible combinations LL, LH, HL and HH. Since the parallel processor produces outputs at twice the speed of the first serial filter SWT1, this is done in two consecutive cycles, the first producing outputs for the combinations LL and LH, and the second producing an output for the combinations HL and HH.

Where an analysis of at more than one level of resolution j is required, the LL output combination is fed back to the second serial processor SWT2. It should be noted that an LL output is produced only once every six clock cycles, and for this reason, the second serial processor SWT2 need operate at only half the rate of the first serial processor SWT1.

As has been discussed, the same memory unit MEM1 is used for storing both low-pass and high-pass output coefficients L, H from the first serial processor SWT1. The first memory unit MEM1, the structure of which is shown in FIG. 2, comprises registers, each represented as a box labelled A in FIG. 2. This structure is suitable for use when boundaries are handled using zero-padding, as described below. The first row of the memory unit MEM1 has a single register. The remaining rows each include 2(└(N+L)/2┘) registers.

As is well known, the wavelet transform process involves decimation by two of the data in each dimension. The parallel processor PWT, therefore, produces an output only for every second row processed by the serial processor SWT1. This allows optimisation in the calculation of the wavelet transform by avoiding (as far as possible) producing an output that would subsequently be lost through decimation. In order to achieve this, the arrangement by which each of the registers within the memory unit MEM1 is clocked depends upon whether an odd-numbered or even-numbered row is being input into the memory unit. Specifically, if a coefficient is placed in an even-numbered row of the memory, it will always be input to the parallel processor PWT in an even-numbered position. Therefore, instead of propagating a coefficient through all rows in the memory, a coefficient that starts in an even-numbered row is propagated only through the even-numbered rows, and likewise coefficients that start in odd-numbered rows are only propagated through odd-numbered rows. During processing of even-numbered rows, only the second row of the memory unit is clocked, while all rows are clocked during processing of odd-numbered rows.

The second memory unit MEM2 comprises several independently controlled registers. In the second memory unit, all rows comprise 2(└((Nj+L)/2┘) registers, where Nj is the number of coefficients input to level j of the DWT. The registers of the second memory unit in this embodiment are clocked in a manner similar to those of the first memory unit MEM1. However, this is the case only where the wavelet transform is zero-padded, and not where it is symmetrically extended. In this embodiment, a register file is used so the coefficients are propagated through each register along every other row.

Since the second serial processor SWT2 is clocked at half the rate of the first serial processor SWT1, the secondary memory unit MEM2 is likewise clocked at half the rate of the first memory unit MEM1. However, while outputting data to the parallel processor PWT, the second memory unit must be clocked at the same speed as the first memory unit.

The memory units and associated control circuitry are designed such that each memory unit is clocked only when there is data available to store and when there are coefficient derived from sufficient rows to compute the DWT along the columns.

In a first embodiment, borders are handled using zero padding. Zero padding is implemented along the rows by holding the first register in the serial processor SWT1 to logic 0 for L-1 cycles. Along the columns, zero padding is implemented by holding the first two rows of the transposing memory to logic ‘0’ for L-1 rows.

It should be noted that the zero padding can have an adverse effect on the time taken to complete a multi-level DWT. When processing, for example, small images with reasonably long filter lengths, the number of resolution levels required may necessitate the stalling of the first serial processor SWT1 for a number of cycles. This is because zero padding extends the image by L-1 samples for each resolution level applied. This can produce a backlog in coefficients computed by the second serial processor SWT2, which must be processed by the parallel processor PWT before the first seal processor SWT1 can proceed. Nevertheless, it has been found that the efficiency of an architecture embodying the invention is still higher than that of known systems. This architecture also allows the complexity of the controller to handle such borders to be minimised. But the length time that the first serial processor SWT1 is stalled can be minimised by using a non-expansive transform to deal with these continuities (e.g. symmetric extension, as described above).

When described mathematically, a DWT assumes that the input data is of infinite extent. This is, of course, not the case in a practical embodiment, where the data is finite and has borders. There are two main ways in which borders can be accommodated within a practical implementation of a DWT, these being referred to a symmetrical extension and zero padding.

A second example uses symmetrical extension. This is a particularly topical example because of the inclusion of this transform in most implementations of the JPEG2000 standard. The circuit, as shown in FIG. 4, is essentially the same as that shown in FIG. 1. To implement symmetrical extension, delay line routers RTA, RTB are provided on the input to the first and serial processors respectively SWTA, SWTB. Further routers RTC, RTD are also provided on the output of the memory MEM1, MEM2, respectively. This routing enables the symmetric extension at the borders of the input image. Also note that this embodiment uses RAM in place of a register in the memory units MEM1, MEM2, therefore an address generator ADR1, ADR2 is also provided for each memory unit. This embodiment unit uses a RAM in which the coefficients propagate down every row. Because the coefficients do not have to propagate along every position in each row there is no significant increase in power consumption.

A simple counter circuit counts the number of rows and columns processed within the input data. The counter circuit provides an input to the routers that determines how the routers direct the data. In particular, this information is used by the router to identify the start and end of each row and column. The input coefficients are stored in delay line. After the L/2 coefficient is input at the start of each row, the counter generates an output signal SOR. While the start of row (SOR) signal is present, the delay line routers mirror the coefficients in each register in the delay line along the centre register. The Serial Processor can now start computing the DWT of these coefficients. This signal is maintained for one cycle only. When the last coefficient has in input to the delay line the end of row (EOR) is generated. At the end of row, the counter's output signal is held for longer (usually around L/2 cycles depending on whether the input sequence and filter length is odd or even) to allow the router to continue to wrap around the input samples. A similar mirroring of coefficients is applied to each column in the data.

The example below illustrates the effect of this configuration on a signal 26 samples long, with coefficients identified A-Z and has an odd-length filter:

TABLE 1

| Coefficients Stored | Start of Row SOR | End of Row EOR |
|---|---|---|
| A _{— — — — — — — —} | 0 | 0 |
| . . . | 0 | 0 |
| D C B A _{— — — — —} | 0 | 0 |
| E D C B A B C D E | 1 | 0 |
| F E D C B A B C D | 0 | 0 |
| . . . | 0 | 0 |
| Y X W V U T S R Q | 0 | 0 |
| Z Y X W V U T S R | 0 | 0 |
| Y Z Y X W V U T S | 0 | 1 |
| X Y Z Y X W V U T | 0 | 1 |
| W X Y Z Y X W V U | 0 | 1 |

The processors used in this particular circuit exploit both the symmetrical nature of the biorthogonal coefficients and the loss of data due to down-sampling. This is done by mirroring the coefficients before they are input to the multiply accumulate structure. The processors used in the first serial processor SWTA of this embodiment have a latency of six clock cycles before producing one output, an input is required every three clock cycles.

Assuming that the first serial processor SWTA includes a 9-tap filter with inputs are X0 . . . X8, with coefficients C0 . . . C8, the six cycle clock process will now be described.

1. In the first cycle, the inputs X8 and X0, X6 and X2, X4 and ‘0’ are added together.

2. In the second cycle the three sums, X8+X0, X6+X2, and X4, are multiplied by C0, C2, and C4 respectively, these three products are then added together.

3. In the third cycle, the output from this product is stored in a register.

4. In the fourth cycle a new set of input coefficients is received. Therefore the coefficients stored in the delay line becomes shifted along by one place. Thus, X7 becomes X8, X2 becomes X3 etc. Now the inputs X8 and X2, X6 and X4, ‘0’ and ‘0’ are added together.

5. In the fifth cycle the three sums, X8+X2, X6+X4, and ‘0’, are multiplied by C1, C3, ‘0’ respectively, these three products are then added together.

6. In the sixth cycle, the sum from the output from the fifth cycle is added to the output from the coefficient stored in the register during the third cycle and output from the processor.

The processors used in the second serial processor SWTB of this embodiment have a latency of twelve clock cycles before producing one output. An input is required every six clock cycles. This fact can be exploited by halving the number of multipliers as combined with the first serial processor SWTA, and increasing the number of coefficients multiplexed as input to the multiplier.

Assuming that the second serial processor SWTB includes a 7-tap filter are X0 . . . X6, with coefficients C0 . . . C6, the six cycle clock process is described below.

1. In the first cycle the inputs X6 and X0 are added together.

2. In the second cycle the sum, X6+X0, is multiplied by C0.

3. In the third cycle, the output from this product is stored in a register.

4. In the fourth cycle the inputs X4 and X2 are added together.

5. In the fifth cycle the sum, X4 and X2, is multiplied by C2.

6. In the sixth cycle, this product is added to the product stored in the register during the third clock cycle.

7. In the seventh cycle a new input is input, therefore the coefficients stored in the delay line becomes shifted along by one place. Thus, X5 becomes X6, X2 becomes X3 etc. Now the inputs X6 and X2, are added together.

8. In the eighth cycle the sum, X6 and X2 is multiplied by C3.

9. In the ninth cycle, this product is added to the product stored in the register during the sixth clock cycle.

10. In the tenth cycle, the inputs X4 and ‘0’ are added together.

11. In the eleventh cycle, the sum, X4+‘0’, is multiplied by C2.

12. In the twelfth cycle, the sum from the output from the eleventh cycle is added to the output from the coefficient stored in the register during the ninth cycle and output from the processor.

The processors used in the parallel processor PWT can take advantage of the symmetry of the biorthogonal coefficients to produce a filter with L/2 multipliers. This produces a three-cycle filter. The filter inputs are added in a similar method as before. The only difference is that the entire set of input coefficients are calculated in one cycle.

An implementation on the Xilinx VIRTEX-2 will now be described, however a similar methodology can be adhered to in an ASIC design.

The operation of the memory MEMA is as follows. Each tap input to the filter has an individual memory unit. This memory unit stores an entire line output from the first serial processor SWTA processor. The coefficients in line propagate through the same location in each memory unit. For example, the coefficient in address 51 in the first memory unit, would be stored in address 51 in the second memory unit after a new line has been processed. The symmetrically extended wavelet transform is handled by having a router at the output of the every memory unit except for the last one. This router feeds the inputs to every memory unit except for the first one. The input from the first one is from SWTA. Both the high and low pass outputs from SWTA are stored in the same memory unit.

The second memory unit MEMB works in the same way, although there is a requirement here that the memory unit be dual port (that is to say, memory that can have read and write accesses simultaneously). The memory unit MEMB stores the lines of the remainder of the resolutions (second or greater). It does this by using one port to store the outputs from the second serial processor SWTB. The other port is used to output coefficients to the parallel processor PWT. E.g. if the circuit is required to do a three resolution wavelet transform then the second memory unit MEMB can be used to output the second resolution coefficients that were outputs from the second memory unit SWTB (essentially, LLL, LLH) to the parallel processor PWT to generate (LLLL, LLLH, LLHL, LLHH). While the parallel processor PWT is generating these outputs, SWTB can be used to create the third resolution coefficients (LLLLL, LLLLH). When the parallel processor PWT is finished processing second resolution outputs it is free to be used to process the third resolution outputs. This may or may not be the case depending on several factors, including border handling (symmetric extension, zero padding etc.), Assuming normal operation (no border handling needed or applied) then the processing of different resolutions should follow FIG. 3.

The component count for the (9,7) and (5,3) filters specified in Part 1 of the JPEG-2000 standard is shown in Table 2, below. It has been found that this component count is comparable with known lifting-based techniques in terms of area consumed.

TABLE 2

| | |
|---|---|
| Multipliers | Adders |

| | (9,7) | (5,3) | (9,7) | (5,3) |
|---|---|---|---|---|
| SWT1 | 5 | 3 | 9 | 5 |
| SWT2 | 3 | 2 | 9 | 5 |
| PWT | 9 | 5 | 14 | 6 |

Hardware utilisation is also better than known architectures. As illustrated in FIG. 3, the parallel processor PWT is active during up to 100% of clock cycles. This also applies to the first serial processor SWT1. The second serial processor SWT2 is active for a minimum of 50% and a maximum of 100(1½j) % of clock cycles.

The embodiment can be implemented using behavioural VHDL. The clock cycle length is determined by the time taken for one multiplication and four additions, this being the delay of the adder in the parallel processor PWT. In this embodiment, no pipelining has been implemented. However, it is expected that it may be possible to improve speed of operation of the architecture by employing pipelining.

1. An architecture component for use in performing a 2-dimensional discrete wavelet transform of 2-dimensional input data, the component comprising a serial processor for receiving the input signal row-by-row, a memory for receiving output coefficients from the serial processor, a parallel processor for processing coefficients stored in the memory, in which the parallel processor is operative to process in parallel coefficients previously derived from one row of input data by the serial processor.

2. An architecture component according to claim 1 in which the serial processor generates both low-pass and high-pass filter output coefficients.

3. An architecture component according to claim 2 in which the memory is capable of storing both such output coefficients.

4. An architecture component according to claim 3 in which the parallel processor is operative to process combinations of the output coefficients in successive processing cycles.

5. An architecture component according to claim 1 in which the memory is configured to order coefficients stored in it into an order suitable for processing by the parallel processor.

6. An architecture component according to claim 1 in which the memory is configured to process coefficients contained in it in a manner that differs in dependence upon whether the coefficients are derived from an odd-numbered or an even-numbered row in the input data.

7. An architecture component according to claim 1 in which the serial the parallel processor and the memory are driven by a clock.

8. An architecture component according to claim 7 in which the memory produces an output at a rate half that at which the parallel processor produces an output.

9. An architecture component according to claim 1 in which the data is extended at its borders.

10. An architecture component according to claim 9 in which the data is extended by symmetric extension.

11. An architecture component according to claim 9 in which the data is extended by zero padding.

12. An architecture component according to claim 9 in which the extension is performed in a memory unit of the architecture.

13. An architecture component according to claim 9 in which the extension is performed by a delay line router component.

14. An architecture component according to claim 1 in which the parallel processor is configured to process data at substantially the same rate as data is output by the first serial processor.

15. An architecture component according to claim 1 further comprising a second serial processor operative to process output from the parallel processor.

16. An architecture component according to claim 15 in which the second serial processor operate to generate one or more further octaves of the discrete wavelet transform.

17. An architecture component according to claim 15 in which the second serial processor processes 25% of coefficients produced by the parallel processor.

18. An architecture component according to claim 17 in which the second serial processor is configured to process data at half the rate of the first serial processor.

19. An architecture component according to claim 1 for use in image processing according to the JPEG 2000 standard.

20. A method of performing a 2-dimensional discrete wavelet transform comprising processing data items in a row of data in a serial processor to generate a plurality of output coefficients, storing the output coefficients in a memory device, and processing the stored coefficients in a parallel processor to generate the transform coefficients.

21. A method according to claim 20 which further includes reordering the coefficients in the memory device.

22. A method according to claim 20 which further includes extending the data at its borders in the memory device.

23. A method according to claim 22 in which the data is extended by either one of zero padding or symmetric extension.

24. A method of encoding or decoding an image in accordance with the JPEG 2000 standard including a method of performing a 2-dimensional discrete wavelet transform according to claim 21.

25. A computer program product comprising computer usable instructions arranged to generate an architecture component as claimed in claim 1.
